(19) United States
(12) Patent Application Publication
(10) Pub. No.: US 2002/0182028 A1
(43) Pub. Date: Dec. 5, 2002

(54) Rivet

(76) Inventor: Chern Hinn-Shing, Taichung (TW)

Correspondence Address: Chern Hinn-Shing, 58 Ma Yuan West St., TAICHUNG, TW

(21) Appl. No.: 09/873,547

(22) Filed: Jun. 1, 2001

(51) Int. Cl. F16B 37/04

(52) U.S. Cl. 411/180

(57) ABSTRACT

A rivet has an inner threaded shank, an annular head connected to the inner threaded shank, and a plurality of embossed pyramids disposed on the inner threaded shank approaching the annular head. Each of the embossed pyramids has a cusp.

### BACKGROUND OF THE INVENTION

The present invention relates to a rivet. More particularly, the present invention relates to a rivet which can fasten an article stably.

Referring to FIGS. 1 and 2, a conventional screw rivet 1 has a sheath 3 to receive a bolt 4. The sheath 3 has a shank 8, a neck 7, a head flange 5, and an inner thread 6 to engage with the bolt 4. An article 1 has a hole 2 to receive the conventional screw rivet 1. However, the hole 2 of the article 1 will be deformed.

### SUMMARY OF THE INVENTION

An object of the present invention is to provide a rivet which can fasten an article stably.

Accordingly, a rivet comprises an inner threaded shank, an annular head connected to the inner threaded shank, and a plurality of pyramids disposed on the inner threaded shank approaching the annular head.

### BRIEF DESCRIPTION OF THE DRAWINGS

FIG. 1 is a perspective exploded view of a conventional screw rivet of the prior art;

FIG. 2 is a sectional assembly view of a conventional screw rivet of the prior art;

FIG. 3 is a perspective view of a rivet of a first preferred embodiment in accordance with the present invention;

FIG. 4 is a perspective view of a rivet of a second preferred embodiment in accordance with the present invention;

FIG. 5 is a perspective view of a rivet of a third preferred embodiment in accordance with the present invention;

FIG. 6 is a perspective view of a rivet of a fourth preferred embodiment in accordance with the present invention;

FIG. 7 is a schematic view illustrating a rivet inserted in a metal article;

FIG. 7A is a sectional view taken along line 7P-7P of FIG. 7;

FIG. 8 is a schematic view illustrating a rivet inserted in a wooden article;

FIG. 8A is a sectional view taken along line 8B-8B of FIG. 8.

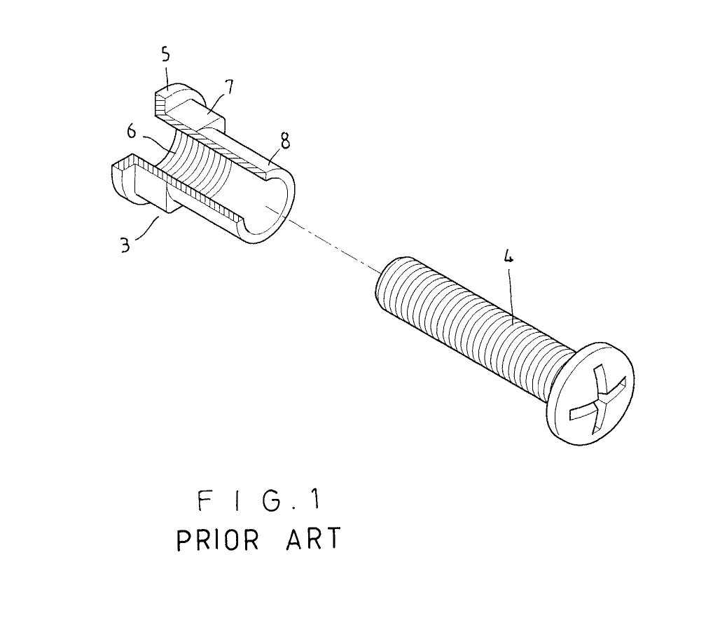

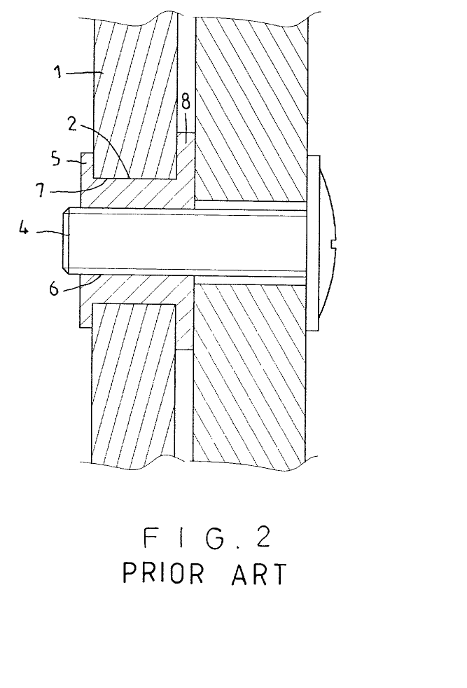

### DETAILED DESCRIPTION OF THE INVENTION

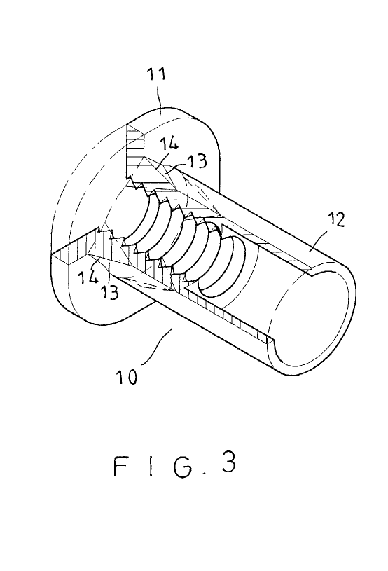

Referring to FIG. 3, a first rivet 10 comprises an inner threaded shank 12, an annular head 11 connected to the inner threaded shank 12, and two embossed pyramids 14 disposed on the inner threaded shank 12 approaching the annular head 11.

Each of the embossed pyramids 14 has a cusp 13 to pierce an article (not shown in the figure).

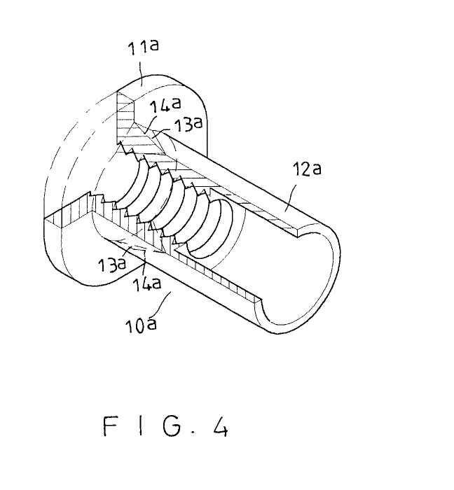

Referring to FIG. 4, a second rivet 10a comprises an inner threaded shank 12a, an annular head 11a connected to the inner threaded shank 12a, and four embossed pyramids 14a disposed on the inner threaded shank 12a approaching the annular head 11a.

Each of the embossed pyramids 14a has a cusp 13a to pierce an article (not shown in the figure).

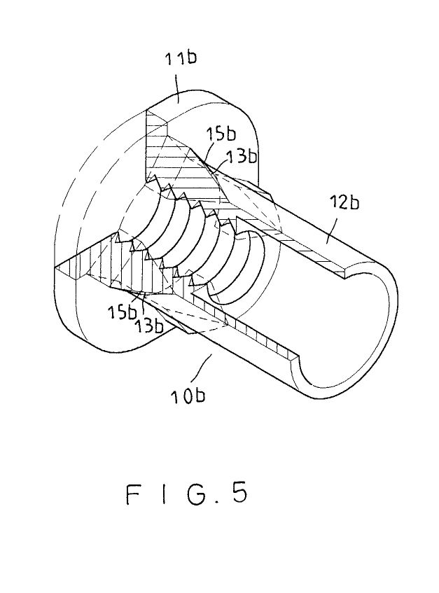

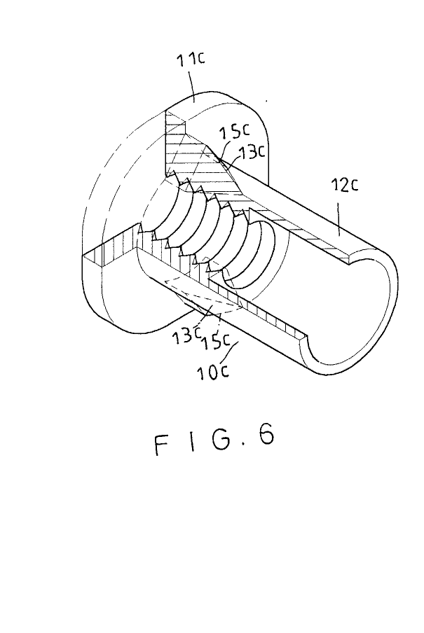

Referring to FIG. 5, a third rivet 10b comprises an inner threaded shank 12b, an annular head 11a connected to the inner threaded shank 12b, and two recessed pyramids 15b disposed on the inner threaded shank 12b approaching the annular head 11b.

Each of the recessed pyramids 15b has a cusp 13b to pierce an article (not shown in the figure).

Referring to FIG. 6, a fourth rivet 10c comprises an inner threaded shank 12c, an annular head 11c connected to the inner threaded shank 12c, and four recessed pyramids 15c disposed on the inner threaded shank 12c approaching the annular head 11c.

Each of the recessed pyramids 15c has a cusp 13c to pierce an article (not shown in the figure).

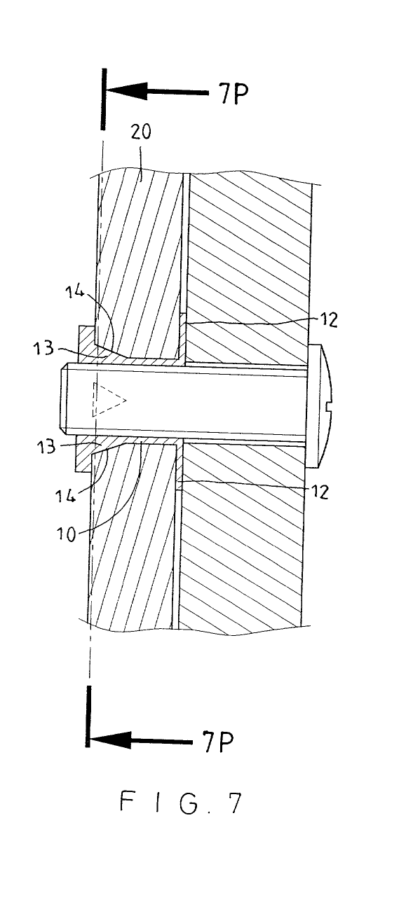

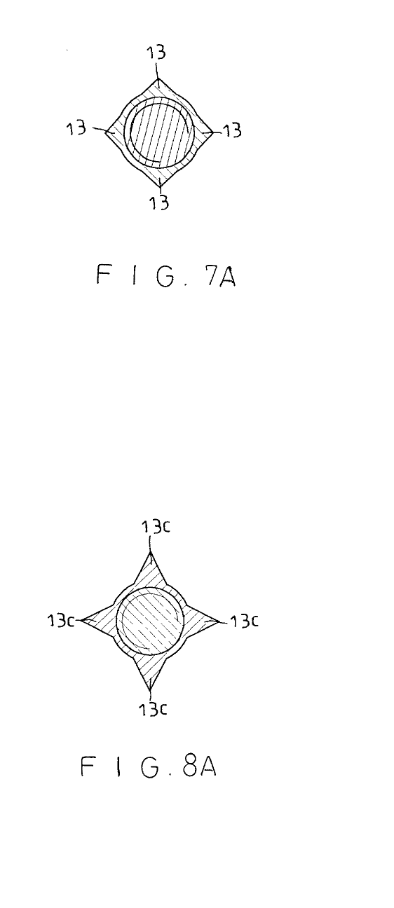

Referring to FIGS. 7 and 7A, the first rivet 10 is inserted in a metal article 20.

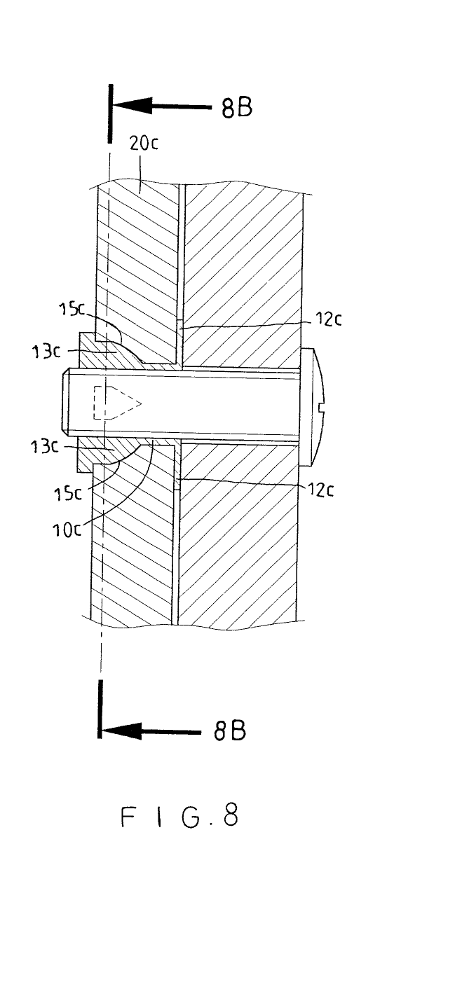

Referring to FIGS. 8 and 8A, the fourth rivet 10c is inserted in a wooden article 20c.

The present invention is not limited to the above embodiments but various modification thereof may be made. Furthermore, various changes in form and detail may be made without departing from the scope of the present invention.

I claim:

1. A rivet comprises:
an inner threaded shank,
an annular head connected to the inner threaded shank, and
a plurality of pyramids disposed on the inner threaded shank approaching the annular head.

2. The rivet as claimed in claim 1, wherein each of the pyramids is an embossed pyramid.

3. The rivet as claimed in claim 1, wherein each of the pyramids is a recessed pyramid.
